(19) United States
(12) Patent Application Publication
(10) Pub. No.: US 2018/0150829 A1
(43) Pub. Date: May 31, 2018

(54) SYSTEM AND METHOD FOR USE IN PERFORMING AN ELECTRONIC TRANSACTION WITH A SMART CARD

(71) Applicant: MASTERCARD INTERNATIONAL INCORPORATED, Purchase, NY (US)

(72) Inventor: Pradip Dagadu Kadam, Pune (IN)

(21) Appl. No.: 15/815,116

(22) Filed: Nov. 16, 2017

(30) Foreign Application Priority Data
Nov. 25, 2016 (SG) 10201609915V

(51) Int. Cl. G06Q 20/34; G06Q 20/36; G06Q 20/20; G06Q 20/32; G06Q 20/40; G06Q 30/06; G06K 19/077

(52) U.S. Cl. CPC G06Q 20/351; G06Q 20/36; G06Q 20/20; G06K 19/07703; G06Q 20/405; G06Q 20/40145; G06Q 30/06; G06Q 20/322

(57) ABSTRACT

There is provided a smart card, a system and method for use in performing an electronic transaction between a user and a merchant, whereby the aforementioned aspects rely on use of virtual payment cards to carry out the transaction.

### BACKGROUND OF THE INVENTION

The present invention relates to a system and method for use in performing an electronic transaction between a user and a merchant using a smart card associated with a plurality of virtual payment cards.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Consumers tend to hold many plastic cards in their wallets, including debit and credit cards from multiple issuing banks and payment switching companies such as Mastercard, Visa and the like, as well as various reward and loyalty cards. Consumers tend to carry all of their cards with them all of the time which leads to bulky and heavy wallets as well as frustration if a person loses their wallet and needs to cancel and replace each lost card.

In practice, each time a card issuer issues a new card to a customer, multiple identity verification processes are performed, known in many countries as Know Your Customer (KYC) processes. KYC processes may involve for example a customer producing several identification documents. The identity verification processes that each card issuer requires tend to be quite similar which therefore makes the KYC processes quite repetitive for the consumer.

Each payment or reward card typically has a personal identification number (PIN) or password associated with it for security and authentication purposes. For enhanced security it is generally better for consumers to use unique PIN or passwords for each card which therefore requires consumers to remember the multiple PIN or passwords when they need to perform a transaction with a particular card.

Typically, whenever a customer's personal details such as name, address, phone number, email/contact address etc. change, the card issuer needs to be notified usually either in person or via electronic banking. This data maintenance activity needs to be performed for each card issuer which is a repetitive and time consuming process.

Another drawback of having multiple cards is that multiple statements are usually received which each have unique payment dates and amounts to be paid for a user to be cognisant of. Having to track multiple payment dates and make multiple repayments towards each card is a cumbersome activity.

Finally, when making purchases and performing electronic transactions either in stores or online through e-commerce sites, consumers constantly have to make a decision about which of their cards to use in the transaction. This can sometimes be a difficult decision and customers may not always be aware what their account balance is at time of purchase.

It is against this background, and the problems and difficulties associated therewith, that the present invention has been developed.

### SUMMARY OF THE PRESENT INVENTION

In a first aspect, there is provided a smart card for use in performing an electronic transaction between a user and a merchant, the smart card including: (a) a data store for storing at least one of: (i) card information associated with a plurality of virtual payment cards; and, (ii) transaction rules indicative of user-defined card usage parameters associated with each of the plurality of virtual payment cards; (b) an electronic processing device that: (i) receives transaction information indicative of one or more parameters of the transaction between the user and merchant; (ii) compares the transaction rules for each of the plurality of virtual payment cards with the transaction information; (iii) selects one of the plurality of virtual payment cards for use in performing the transaction in accordance with results of the comparison; and, (iv) provides card information associated with the selected virtual payment card to the merchant to thereby enable the transaction to be performed.

There is also provided a smart card for use in performing an electronic transaction between a user and a merchant, the smart card including: (a) a data store for storing at least one of: (i) card information associated with a plurality of virtual payment cards; and, (ii) transaction rules indicative of user-defined card usage parameters associated with each of the plurality of virtual payment cards; (b) an electronic processing device that: (i) receives transaction information indicative of one or more parameters of the transaction between the user and merchant; (ii) determines whether the smart card is set in automatic or manual mode; and, (iii) in response to determining that automatic mode is set: (1) retrieves the transaction rules from the data store; (2) compares the transaction rules for each of the plurality of virtual payment cards with the transaction information; (3) selects one of the plurality of virtual payment cards for use in performing the transaction in accordance with results of the comparison; (4) retrieves card information associated with the selected virtual payment card from the data store; and, (5) provides the card information to the merchant to thereby enable the transaction to be performed; and, (iv) in response to determining that manual mode is set: (1) retrieves card information associated with a user selected virtual payment card from the data store; and (2) provides the card information to the merchant to thereby enable the transaction to be performed.

There is also provided a smart card for use in performing an electronic transaction between a user and a merchant, the smart card associated with at least one of: (i) card information associated with a plurality of virtual payment cards; and, (ii) transaction rules indicative of user-defined card usage parameters associated with each of the plurality of virtual payment cards. It is preferable that the card information and transaction rules are stored on a remote server accessible by a merchant system to enable the transaction using the smart card to be performed.

In a separate aspect, there is provided a system for use in performing an electronic transaction between a user and a merchant using a smart card associated with a plurality of virtual payment cards, the system including one or more electronic processing devices that: (a) determine transaction information in response to the user initiating a transaction with a merchant using the smart card, the transaction information indicative of one or more parameters of the transaction between the user and merchant; (b) determine transaction rules indicative of user-defined card usage parameters associated with each of the plurality of virtual payment cards; (c) compare the transaction rules for each of the plurality of virtual payment cards with the transaction information; (d) determine one of the plurality of virtual payment cards for use in performing the transaction in accordance with results of the comparison; and, (e) provide card information associated with the virtual payment card determined for use to the merchant to thereby enable the transaction to be performed.

There is also provided a method for use in performing an electronic transaction between a user and a merchant using a smart card associated with a plurality of virtual payment cards, the method including in one or more electronic processing devices: (a) determining transaction information in response to the user initiating a transaction with a merchant using the smart card, the transaction information indicative of one or more parameters of the transaction between the user and merchant; (b) determining transaction rules indicative of user-defined card usage parameters associated with each of the plurality of virtual payment cards; (c) comparing the transaction rules for each of the plurality of virtual payment cards with the transaction information; (d) determining one of the plurality of virtual payment cards for use in performing the transaction in accordance with results of the comparison; and, (e) providing card information associated with the virtual payment card determined for use to the merchant to thereby enable the transaction to be performed.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which:

FIG. 1 is a flow chart of an example of a method for use in performing an electronic transaction between a user and a merchant using a smart card associated with a plurality of virtual payment cards;

FIG. 2 is a schematic diagram of an example of a system for use in performing an electronic transaction between a user and a merchant using a smart card associated with a plurality of virtual payment cards;

FIG. 3 is a schematic diagram of an example of a smart card processing system embedded into the smart card;

FIG. 4 is a schematic diagram of a further example of a smart card processing system implemented by a remote or central server;

FIG. 5 is a schematic diagram of an example of a merchant terminal;

FIG. 6 is a schematic diagram of an example of a client device;

FIG. 7 is a flowchart of an example of a specific process of performing a merchant transaction using a smart card;

FIG. 8 is a flowchart of a further example of a specific process of performing a merchant transaction using a smart card;

FIG. 9 is a flowchart of an example of a process of registering a digital wallet and creating virtual payment cards;

FIG. 10 is a flowchart of an example of a process of transferring virtual payment cards from a digital wallet to a smart card;

FIG. 11 is a flowchart of an example of a process of linking virtual payment cards to a smart card;

FIG. 12 is a schematic diagram of an example of the interactions involved in a typical smart card based transaction process;

FIG. 13 is a schematic diagram of a further example of the interactions involved in a typical smart card based transaction process; and,

FIG. 14 is a schematic diagram of an example of payment flow for the plurality of virtual payment cards.

### DETAILED DESCRIPTION OF THE PREFERRED EMBODIMENTS

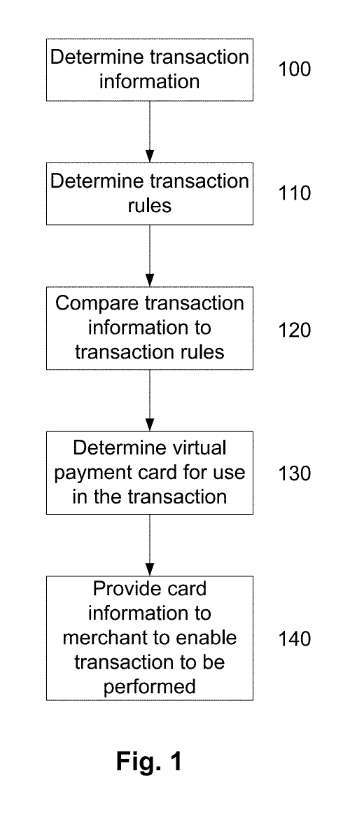

An example of a method for use in performing an electronic transaction between a user and merchant using a smart card associated with a plurality of virtual payment cards shall now be described with reference to FIG. 1.

A “virtual payment card” in the context of this disclosure may represent an existing plastic card (e.g. debit, credit, rewards card) that has been digitised by adding it to a digital or mobile wallet. Alternatively, a virtual payment card may be created when a new payment card is issued electronically by an issuer to a digital wallet of the user.

For the purpose of illustration, it is assumed that the method is performed at least in part using one or more electronic processing devices including a merchant terminal (e.g. point of sale (POS) device) in communication with a smart card and smart card processing system, which may be embedded into the smart card or alternatively be implemented by a central server or the like. The POS device is typically also in communication with a payment processing system which may include a number of processing devices associated with each of an issuer, acquirer, card network and payment gateway, or alternatively, the payment processing system may be any one or more of these entities and this will be discussed further below.

In this example, at step 100, the one or more electronic processing devices determine transaction information in response to the user initiating a transaction with a merchant using the smart card, the transaction information indicative of one or more parameters of the transaction between the user and merchant. The transaction may be initiated at a merchant location for example when a user presents their smart card to a POS terminal. Alternatively, the transaction may be an e-commerce transaction performed online at a merchant store or through a merchant application executing on a user device. In an e-commerce environment, the user would provide a smart card identifier such as a card number, expiry date etc. at a checkout in the same manner that a traditional online transaction is performed using a payment card. At point of sale, the user would initiate the transaction by inserting, swiping or tapping their smart card against the merchant POS terminal.

Typically, the transaction information is generated by a merchant system and transmitted to a smart card processing system which may be a remote or central server or a processing device embedded onto the smart card itself. The transaction information may include parameters such as a transaction amount, a merchant identifier indicative of a type of merchant (e.g. grocery store, white goods retailer, restaurant, bar etc.), a date of transaction and a location of transaction (for example point of sale, ecommerce, local/overseas etc.). The transaction information is processed by the smart card processing system in order to select one of the plurality of virtual payment cards for use in performing the transaction as shall be described in further detail below.

At step 110, the one or more electronic processing devices determine transaction rules indicative of user-defined card usage parameters associated with each of the plurality of virtual payment cards. The transaction rules may be stored on the smart card by a specific application or alternatively on the central server. The card usage parameters or preferences are defined by the user in a mobile or digital wallet application in which the plurality of virtual payment cards are stored. The usage parameters are then transferred onto the smart card or to the central server. The transaction rules may be structured in any suitable way in order to define logic to enable the smart card processing system to determine an appropriate virtual payment card for use in performing the transaction. Examples of transaction rules are provided below for the purpose of illustration only and it is to be understood that the rules could be programmed in any suitable way. Furthermore, it is to be understood that transaction rules may be defined in respect of one or more of the example parameters and further logic may be implemented to give precedence to one rule over another, for example when rules are in conflict with one another.

a) Amount:
i) $0-$100: Debit card A;
ii) $101-$500: Debit Card B;
iii) $501-$1,000 Credit Card C;
iv) Greater than $1,000: Credit Card D.

b) Merchant Identifier:
i) Grocery store: Debit Card A;
ii) Restaurant: Debit Card B;
iii) White Goods Retailer: Credit Card C.

c) Location of card use:
i) Point of sale: Debit Card A;
ii) E-commerce: Credit Card C;
iii) Overseas: Credit Card D.

d) Date of Transaction:
i) Day 1 to 15 of month: Debit Card A;
ii) Day 16 to 31 of month: Debit Card B.

At step 120, the transaction rules for each of the plurality of virtual payment cards are compared to the transaction information. This comparison may be performed by a decision engine such as a smart card usage preference application that is able to analyse the transaction parameters using the transaction rules in order to determine the virtual payment card for use in the performing the transaction with the merchant. In an example of a transaction, the user initiates a point of sale purchase for $75 at a local grocery store on 3 June. The smart card processing system compares the transaction parameters with the transaction rules defined above and determines that Debit Card A is to be used to perform the transaction. If the transaction amount was $150 then further logic would be required to determine whether Debit Card A or Debit Card B should be used. For example, a card could be selected based on one parameter being weighted higher than the others or a card could be selected if more parameters than not indicate that a particular card should be selected.

Accordingly, at step 130 the one or more electronic processing devices determine one of the plurality of virtual payment cards for use in performing the transaction in accordance with results of the comparison.

Finally, at step 140 card information associated with the virtual payment card determined for use is provided to the merchant to thereby enable the transaction to be performed. Typically, having determined the virtual payment card to be used, the smart card processing system sends card information such as card number, expiry date, card verification value (CVV), account name etc. to the merchant system (e.g. merchant terminal or processing system). The merchant terminal then causes the transaction to be performed using the provided card information associated with the selected virtual payment card by requesting authorization in the usual manner through a payment processing system (e.g. including acquiring bank, issuing bank, card network and payment gateway).

It will be appreciated that the above described method provides a number of benefits. For example, the above described method allows users to have all of their debit, credit and reward cards all conveniently stored on or linked to a single physical smart card. It is no longer necessary to carry around multiple plastic cards in a wallet or purse which previously was very bulky and cumbersome as a result of carrying around so many cards. Since the smart card can be associated with any number of virtual payment cards, issuers can issue multiple cards to the user who is likely to be more inclined to want and/or to use cards that they previously wouldn't have due to the limitations of carrying them around.

The ability to have pre-defined card usage parameters or preferences set for each of the plurality of virtual payment cards means that the user doesn't have to constantly make decisions about which card should be used for a particular transaction which thereby enhances ease of usage and creates a better user experience in performing transactions with merchants.

Furthermore, issuers no longer have to issue plastic cards to customers which saves cost associated with materials, postage etc. and speed up issuance of new cards to customers. Further advantages of the method shall become apparent from the description below.

A number of further features will now be described.

As previously described, the transaction with the merchant may be initiated at one of a point of sale at a merchant premises, or an e-commerce store. At a merchant premises, the user would present their smart card to a merchant POS terminal in a conventional manner. If shopping at an e-commerce website or the like, the user would typically provide their card details to a payment application or checkout provided by the merchant in order to initiate the payment transaction.

Typically, when the user initiates the transaction with the merchant, an indication of a card identifier is provided to a merchant system. The card identifier indicates that the card is a smart card and may be any suitable identifier such as a number, sequence of digits, alpha-numeric string etc. The merchant system is responsive to receiving the indication of the card identifier to determine that the card identifier is indicative of a smart card associated with a plurality of virtual payment cards. Having determined that a smart card has been presented for use in performing the transaction, the merchant system proceeds to generate the transaction information and provide an indication of the transaction information to a smart card processing system.

It is to be appreciated that as previously indicated, the smart card processing system could either be embedded onto the smart card or form part of a remote or central server. Accordingly, the smart card may have its own processing ability or the card itself may simply just indicate that is a card associated with or linked to a plurality of virtual payment cards and be able to direct the merchant system to a central server where card information associated with the each of the virtual payment cards, transaction rules etc. are stored.

Typically, the smart card processing system is responsive to receiving the indication of the transaction information to determine the transaction rules associated with each of the plurality of virtual payment cards associated with the smart card, compare the transaction rules to the transaction information, and select the virtual payment card in accordance with results of the comparison as previously described. According, these steps may be performed by a card processor or on the central server, depending on how the system is implemented.

In one example, the smart card processing system retrieves card information associated with the selected virtual payment card, and provides the card information to the merchant system. The card information may be retrieved from a data store on the smart card or alternatively from the central server or database coupled to the server. The card information may vary depending on what is required by the merchant to process the transaction but may include of a card number, an issuer name, an issue date, an expiry date, a card verification value (CVV), an account name, and, an account balance.

Typically, before the transaction can be processed, the user will be prompted to provide authentication information such as a personal identification number (PIN), a password, or a biometric identifier such as a finger print or the like. The security feature may be at a global level (i.e. for the smart card and applicable to each virtual payment card associated with or liked to the smart card) or at an individual virtual payment card level. If a single security feature is used for the smart card at a global level, this can further make it easier for a user to perform a transaction as they don't need to remember multiple passwords, PIN numbers etc. In accordance with the above, in response to receiving the selected card information, the merchant system may prompt the user to provide authentication information, selectively authenticate the user using the authentication information, and, initiate payment authorisation with a payment processing system in response to successful authentication.

The card information associated with each of the plurality of virtual payment cards and transaction rules associated with said payment cards are typically associated with a digital or mobile wallet of the user. In this regard, a user typically applies to register a digital wallet where existing payment cards can be uploaded and/or issuers can issue new payment cards electronically. After creating virtual payment cards in the digital wallet, the user can create the transaction rules by defining card usage parameters associated with each of the plurality of virtual payment cards. The card information and transaction rules are then transferred from the digital wallet to the smart card processing system. In one example, the card information and transaction rules are stored in a data store embedded onto the smart card and in another example the card information and transaction rules are stored on the central server.

In the case of the smart card having an embedded processor and memory, the card information and transaction rules are either wirelessly or via physical connectors, transferred to the smart card via one of a card reader attached to a user device associated with the digital wallet, an automated teller machine (ATM), or a payment terminal, such as one compliant with the Europay, Mastercard and Visa (EMV) standard. For example, a user may attach a card reader to their user device such as a smart phone, tablet or the like that has the digital or mobile wallet application. The reader may be authorised to access the digital wallet by some means of access control (such as a PIN, password, finger print, selfie etc.). The user then brings the smart card into close proximity with the reader which is responsive to read the card information and transaction rules associated with each of the plurality of virtual payment cards from the digital wallet and store the data on the smart card.

When registering the digital wallet, the user provides identity information to a wallet provider, the wallet provider being responsive to verify the user's identity in accordance with standard Know Your Customer (KYC) protocols. In one example, the user provides KYC documents such as Proof of Identity (PoI), Proof of Address (PoA) and personal details such as name, address, photo, gender, date of birth, phone, mobile, email etc. The KYC documents may be uploaded to a server where they are stored and verified by the wallet provider. Once verified, the user is stamped as KYC approved and the wallet is registered. The wallet provider may seek regular KYC checks from the user in accordance with regulator guidelines where the user repeats the process of providing KYC documents for verification by the wallet provider.

Alternatively, instead of the user providing their own KYC documentation, the wallet provider may use an external e-KYC service provider (e.g. UIDAI e-KYC in India) to authenticate the customer at registration and also on a regular basis. Typically, when using an external e-KYC service, the user provides identity information such as a unique identification number (e.g. Aadhar number in India) and biometric information such as a finger print scan or alternatively a one-time password (OTP). This information is sent to the external e-KYC service provider who uses the information to authenticate the user and provider an indication back to the wallet provider whether or not the user is KYC approved. If KYC authentication is successful, the digital wallet is registered and ready for use.

In one example, after the one-time KYC approval process to register the digital wallet, the user is able to apply for a new payment card from an issuer, the issuer being responsive, without further identity verification to issue a new payment card, and embed said payment card in the user's digital wallet as a virtual payment card. Alternatively, the user can upload card information associated with one or more existing payment cards into the digital wallet to create one or more virtual payment cards. After the virtual payment cards have been created in the digital wallet, the user may define the card usage parameters for each of the plurality of virtual payment cards.

In one broad form, there is provided a smart card for use in performing an electronic transaction between a user and a merchant, the smart card including a data store for storing at least one of card information associated with a plurality of virtual payment cards, and, transaction rules indicative of user-defined card usage parameters associated with each of the plurality of virtual payment cards. The data store or memory may be sufficient to store information associated with a certain number of cards, for example 10, 20, 30, 40 virtual cards. The smart card may further include an electronic processing device that receives transaction information indicative of one or more parameters of the transaction between the user and merchant, compares the transaction rules for each of the plurality of virtual payment cards with the transaction information, selects one of the plurality of virtual payment cards for use in performing the transaction in accordance with results of the comparison, and, provides card information associated with the selected virtual payment card to the merchant to thereby enable the transaction to be performed.

In one example, the smart card may be operable in automatic and manual modes that the user can select prior to use. The smart card may include a user interface for allowing the user to select whether the card is to be operated in automatic or manual mode. In manual mode, the user can manually select a particular virtual payment card for use in performing the transaction. In automatic mode, the smart card processing system will automatically select the appropriate virtual payment card for use at the time of performing the transaction in accordance with the transaction rules defined for each card. If manual mode is selected, the pre-set card usage preferences are able to be overridden.

Accordingly, in one example, the smart card processor may be configured to determine whether the smart card is set in automatic or manual mode. In response to determining that automatic mode is set, the card processor retrieves the transaction rules from the data store, compares the transaction rules for each of the plurality of virtual payment cards with the transaction information, selects one of the plurality of virtual payment cards for use in performing the transaction in accordance with results of the comparison, retrieves card information associated with the selected virtual payment card from the data store and, provides the card information to the merchant to thereby enable the transaction to be performed.

Alternatively, in response to determining that manual mode is set, the card processor retrieves card information associated with a user selected virtual payment card from the data store, and provides the card information to the merchant to thereby enable the transaction to be performed.

The smart card may additionally include a display and the processing system may be configured to determine the virtual payment card that has been selected for use in performing the transaction, generate a representation indicative of the selected virtual payment card, and, display the representation on the display. In a manual mode of operation, once a particular virtual payment card is selected on the display of the smart card, the smart card effectively becomes that card until another virtual payment card is selected.

In another example, there is provided a smart card for use in performing an electronic transaction between a user and a merchant, the smart card associated with at least one of card information associated with a plurality of virtual payment cards, and transaction rules indicative of user-defined card usage parameters associated with each of the plurality of virtual payment cards, wherein, the card information and transaction rules are stored on a remote server accessible by a merchant system to enable the transaction using the smart card to be performed. In this example, the smart card does not store the virtual payment card information or transaction rules and is instead just linked to the remote or central server which may have a database for example that stores the information. In this example, the smart card may simply provide an identifier to the merchant terminal which is used to interrogate the remote server to retrieve the necessary information to enable the transaction to be performed.

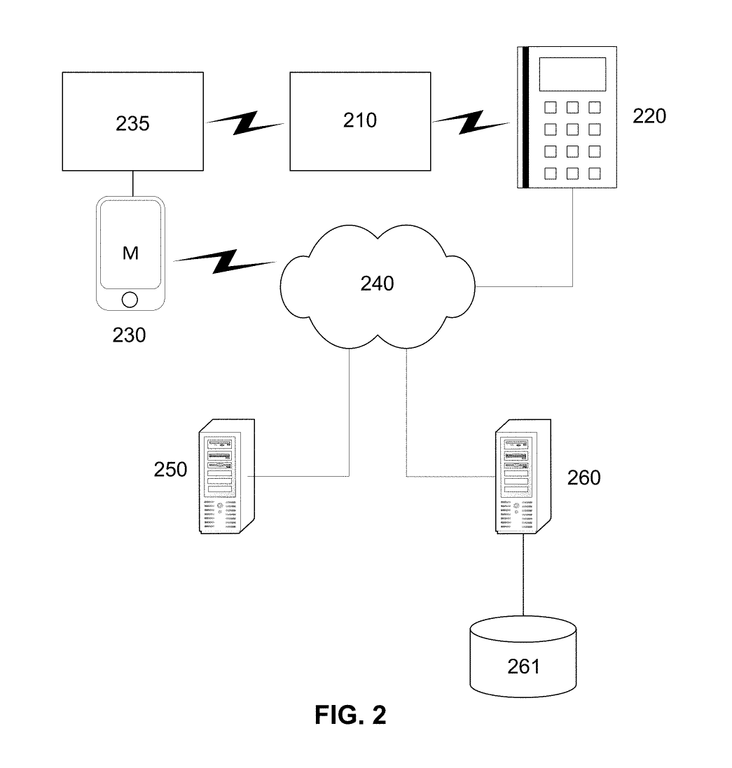

In one example, the process is performed by one or more processing systems operating as part of a distributed architecture, an example of which will now be described with reference to FIG. 2.

In this example, a smart card 210 associated with a plurality of virtual payment cards is configured to communicate with a merchant terminal 220 in order to initiate a transaction between the user and a merchant. The merchant terminal 220 is in communication with a payment processing device 250 via one or more communications networks 240, such as the Internet, and/or a number of local area networks (LANs). The merchant terminal 220 may further communicate with a remote or central smart card processing system 260 via the one or more communications networks 240, or alternatively may communicate with a smart card processing system embedded into the smart card 210. A client device 230 of the user having a mobile wallet application may also be coupled to the remote smart card processing system 260 via the communications network 240 or alternatively may be configured to transfer information directly to the smart card 210 via a card reader 235 attached to the client device 230.

The merchant terminal 220 may include any suitable processing device, such as a computer system, server(s), personal computer, POS terminal, or the like. Similarly, the payment processing device(s) 250 may also include any suitable processing device such as computer system(s), server(s), and/or may be composed of a number of different processing systems for example related to an acquirer, issuer, card network, and payment gateway.

The client device 230 typically includes a mobile device, such as a tablet or smartphone, however may also include any suitable processing system, and this will also be described in more detail below.

The smart card 210 may include an embedded processing device suitable for communicating with the merchant terminal 220 and may include a microprocessor, microchip processor, or any other electronic device, system or arrangement, typically with one or more external interfaces, as will be described in further detail below. The embedded processing device may optionally store card information and transaction rules associated with the plurality of virtual payment cards. Alternatively, the card information and rules may be linked to the smart card and stored in a remote or central smart card processing device 260 such as a computer system or server. The card information and rules may be transferred from the mobile wallet application executing on the client device 230 to the central server 260, where it is optionally stored in database 261 coupled to the server 260.

It will be appreciated that the configuration of the networks 240 is for the purpose of example only, and in practice the smart card 210, merchant terminal 220, payment processing device 250, central server 260, and client device 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In use, the processing system on the smart card 210 or central server 260 is adapted to be used in comparing transaction information to transaction rules so as to determine one of the plurality of virtual payment cards that is suitable for use in performing the transaction with the merchant and providing card information associated with the selected virtual payment card to the merchant terminal.

Whilst the central server 260 is a shown as a single entity, it will be appreciated that the remote smart card processing system can be distributed over a number of geographically separate locations, for example by using processing systems 260 and/or databases 261 that are provided as part of a cloud based environment. However, the above described arrangement is not essential and other suitable configurations could be used.

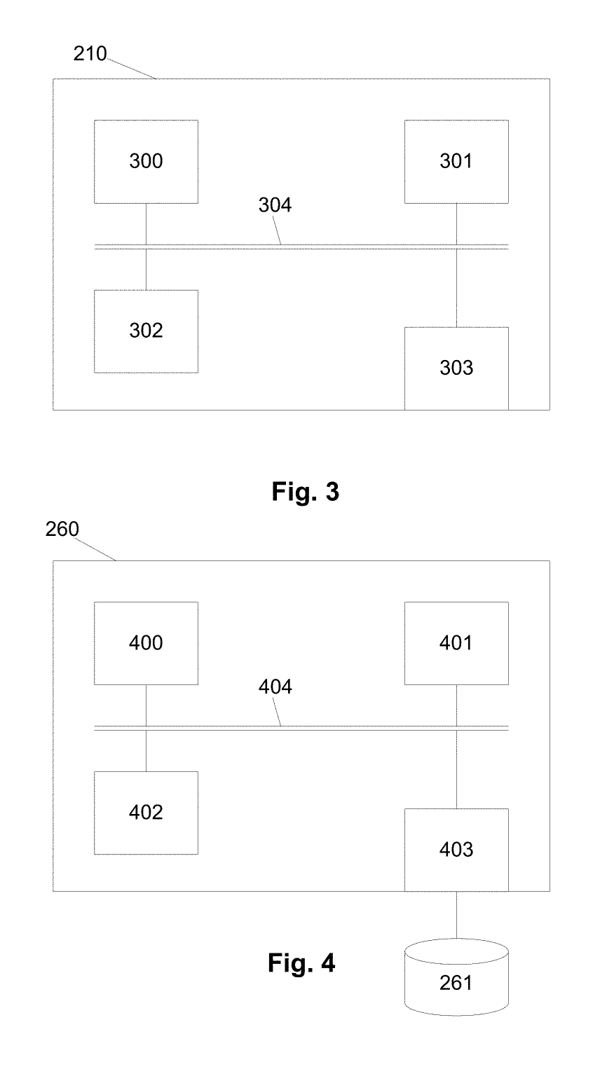

An example of a suitable smart card processing system 210 is shown in FIG. 3. In this example, the processing system 210 includes at least one microprocessor 300, a memory 301, an optional input/output device 302, such as a switch, button and/or display, and an external interface 303, interconnected via a bus 304 as shown. In this example the external interface 303 can be utilised for connecting the processing system 210 to peripheral devices, such as a card reader associated with a client device for transferring virtual payment card information or a card reader associated with a merchant terminal for initiating a transaction with the merchant. Although a single external interface 303 is shown, this is for the purpose of example only, and in practice multiple interfaces using various wireless methods may be provided.

In use, the microprocessor 300 executes instructions in the form of applications software stored in the memory 301 to allow the smart card to compare transaction information with transaction rules stored in memory or the like in order to select a virtual payment card for use in performing the transaction. The applications software may include one or more software modules, and may be executed in a suitable execution environment, such as an operating system environment, or the like.

Accordingly, it will be appreciated that the processing system 210 could be any suitable electronic processing device such as a microprocessor, microchip processor, logic gate configuration, firmware optionally associated with implementing logic such as an FPGA (Field Programmable Gate Array), or any other electronic device, system or arrangement. In one particular example, the processing system 210 is a standard processing system such as an Intel Architecture based processing system, which executes software applications stored on non-volatile (e.g., hard disk) storage, although this is not essential.

An example of a suitable remote smart card processing system 260 is shown in FIG. 4. In this example, the processing system 460 includes at least one microprocessor 400, a memory 401, an optional input/output device 402, such as a keyboard and/or display, and an external interface 403, interconnected via a bus 404 as shown. In this example the external interface 403 can be utilised for connecting the processing system 260 to peripheral devices, such as the communications networks 240, databases 261, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401 to allow the required processes to be performed. The applications software may include one or more software modules, and may be executed in a suitable execution environment, such as an operating system environment, or the like.

Accordingly, it will be appreciated that the processing system 260 may be formed from any suitable processing system, such as a suitably programmed computer system, web server, network server, or the like. In one particular example, the processing system 260 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

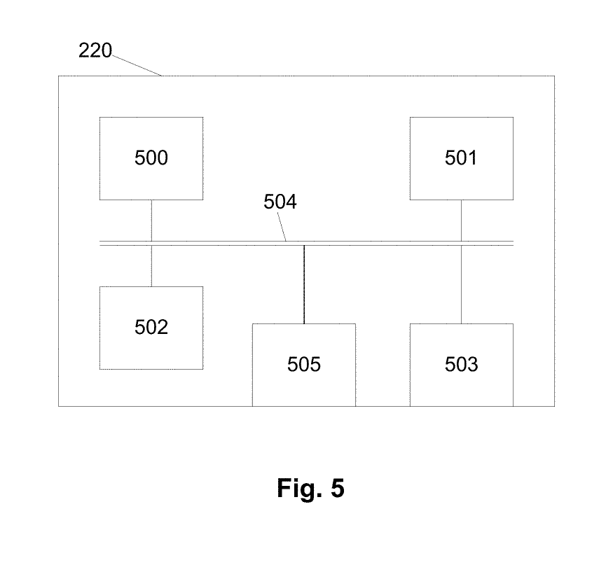

As shown in FIG. 5, in one example, the merchant device 220 includes at least one microprocessor 500, a memory 501, an input/output device 502, such as a keyboard and/or display, an external interface 503, and typically a card reader 505, interconnected via a bus 504 as shown. In this example the external interface 503 can be utilised for connecting the merchant device 220 to peripheral devices, such as the communications networks 240, databases, other storage devices, or the like. Although a single external interface 503 is shown, this is for the purpose of example only, and in practice multiple interfaces using various methods (e.g. Ethernet, serial, USB, wireless or the like) may be provided. The card reader 505 can be of any suitable form and could include a magnetic card reader, or contactless reader for reading the smart card.

In use, the microprocessor 500 executes instructions in the form of applications software stored in the memory 501, and to allow communication with the smart card 210, payment processing system 250 or central server 260.

Accordingly, it will be appreciated that the merchant device 220 may be formed from any suitable processing system, such as a suitably programmed PC, Internet terminal, lap-top, or handheld PC, and in one preferred example is either a POS terminal, or a tablet, or smart phone, with integrated or connected card reading capabilities. However, it will also be understood that the merchant devices 220 can be any electronic processing device such as a microprocessor, microchip processor, logic gate configuration, firmware optionally associated with implementing logic such as an FPGA (Field Programmable Gate Array), or any other electronic device, system or arrangement.

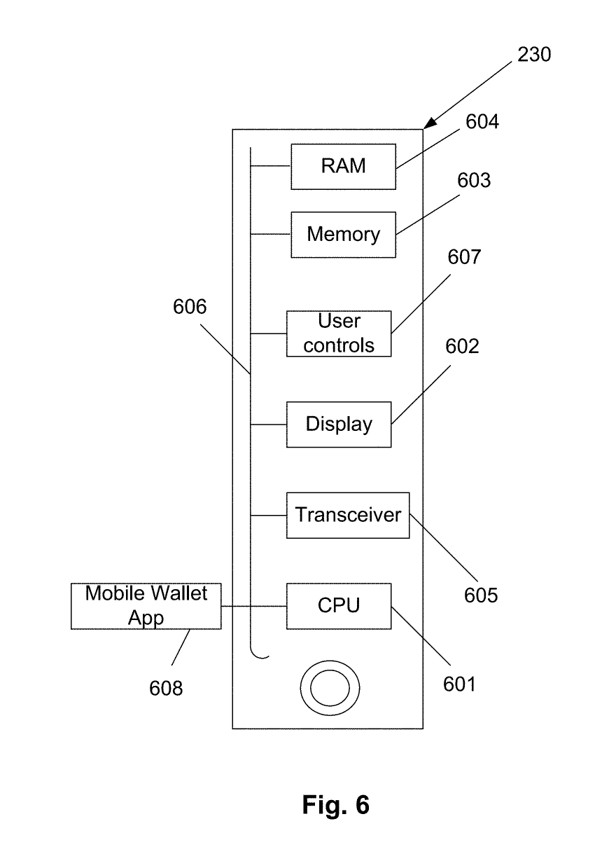

The client device 230 of any of the examples herein may be a handheld computer device such as a smart phone or a PDA such as one manufactured by Apple™, LG™, HTC™, Research In Motion™, or Motorola™. The client device 230 may include a mobile computer such as a tablet computer. An exemplary embodiment of a client device 230 is shown in FIG. 6. As shown, the device 230 includes the following components in electronic communication via a bus 606:

1. a display 602;

2. non-volatile memory 603;

3. random access memory (“RAM”) 604;

4. N processing components 601;

5. a transceiver component 605 that includes N transceivers; and

6. user controls 607.

Although the components depicted in FIG. 6 represent physical components, FIG. 6 is not intended to be a hardware diagram; thus many of the components depicted in FIG. 6 may be realized by common constructs or distributed among additional physical components. Moreover, it is certainly contemplated that other existing and yet-to-be developed physical components and architectures may be utilized to implement the functional components described with reference to FIG. 6.

The display 602 generally operates to provide a presentation of content to a user, and may be realized by any of a variety of displays (e.g., CRT, LCD, HDMI, micro-projector and OLED displays). And in general, the non-volatile memory 603 functions to store (e.g., persistently store) data and executable code including code that is associated with the functional components of a browser component and applications, and in one example, the mobile or digital wallet application 408. In some embodiments, for example, the non-volatile memory 403 includes bootloader code, modem software, operating system code, file system code, and code to facilitate the implementation of one or more portions of the digital wallet application 408 as well as other components well known to those of ordinary skill in the art that are not depicted for simplicity.

In many implementations, the non-volatile memory 403 is realized by flash memory (e.g., NAND or ONENAND memory), but it is certainly contemplated that other memory types may be utilized as well. Although it may be possible to execute the code from the non-volatile memory 603, the executable code in the non-volatile memory 603 is typically loaded into RAM 604 and executed by one or more of the N processing components 601.

The N processing components 601 in connection with RAM 604 generally operate to execute the instructions stored in non-volatile memory 603 to effectuate the functional components. As one of ordinarily skill in the art will appreciate, the N processing components 601 may include a video processor, modem processor, DSP, graphics processing unit (GPU), and other processing components.

The transceiver component 605 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

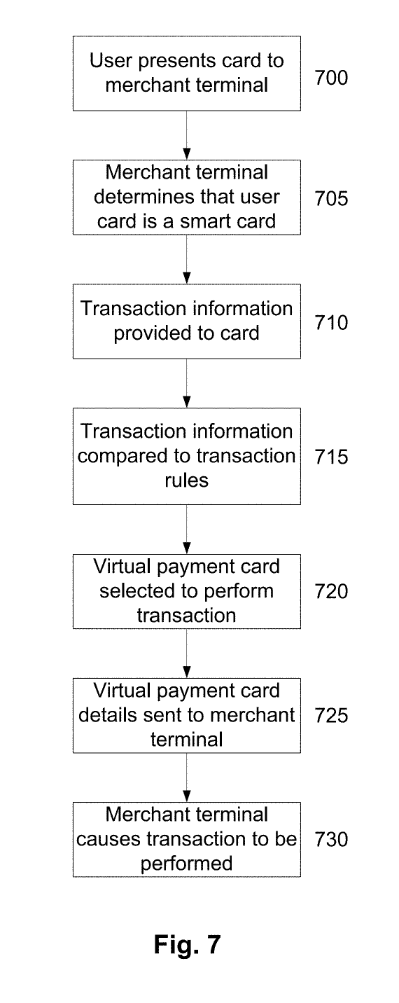

An example process of a method for use in performing an electronic transaction between a user and a merchant using a smart card associated with a plurality of virtual payment cards will now be described in more detail with reference to FIG. 7.

In this example, at step 700 a user presents the smart card 210 (operating in automatic mode) to a merchant terminal 220 for example at point of sale by swiping, inserting or tapping the card in a conventional manner. At step 705, the merchant terminal 220 determines that the card being presented for payment is a smart card. The smart card 210 may for example provide an identifier to the merchant terminal 220 which recognises that the identifier is from a smart card. After determining that a smart card has been presented, the merchant terminal 220 provides transaction information to the smart card 210 at step 710. As previously described, the transaction information may include parameters such as a transaction amount, a merchant identifier indicative of a type of merchant (e.g. grocery store, white goods retailer, restaurant, bar etc.), a date of transaction and a location of transaction (for example point of sale, ecommerce, local/overseas etc.).

At step 715, the transaction information is compared to transaction rules indicative of user-defined card usage parameters associated with each of the plurality of virtual payment cards. In this example, the transaction rules are stored in a card usage application executable on the smart card 210 such that the processing is performed locally by the smart card 210. At step 720, a virtual payment card is selected to perform the transaction in accordance with the results of the comparison and at step 725 the selected virtual payment card details such as card number, expiry date, CVV etc. are sent to the merchant terminal 220 which then causes the transaction to be performed at step 730 by initiating payment authorisation using the selected card details in accordance with standard payment processing protocols.

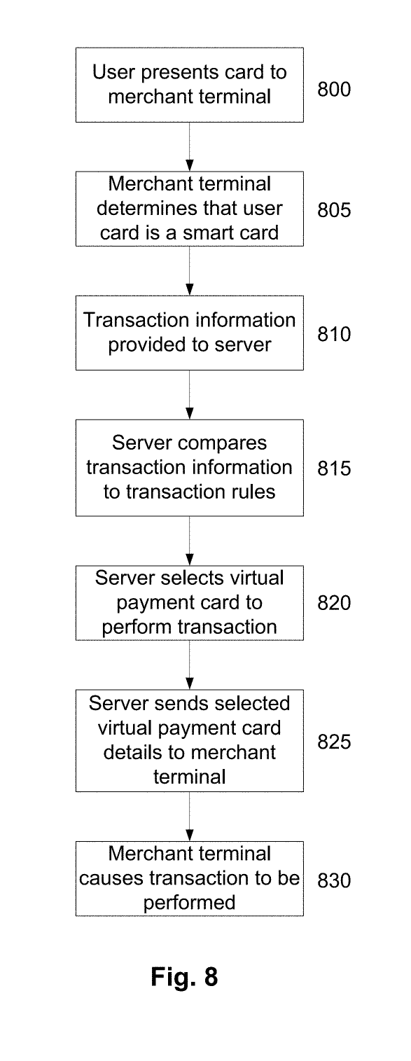

Another example process of a method for use in performing an electronic transaction between a user and a merchant using a smart card associated with a plurality of virtual payment cards will now be described in more detail with reference to FIG. 8.

In this example, at step 800 a user presents the smart card 210 (operating in automatic mode) to a merchant terminal 220 for example at point of sale by swiping, inserting or tapping the card in a conventional manner. At step 805, the merchant terminal 220 determines that the card being presented for payment is a smart card that is linked to a plurality of virtual payment cards. The smart card 210 may for example provide an identifier to the merchant terminal 220 which recognises that the identifier is from a smart card. After determining that a smart card has been presented, the merchant terminal 220 provides transaction information to a central server 260 at step 810, for example coupled to a database 261 storing card information associated with each of the plurality of virtual payment cards along with the transaction rules governing the usage of each card.

At step 815, the central server 260 compares the transaction information to the transaction rules for each of the plurality of virtual payment cards linked to the smart card 210. At step 820, the central server 260 selects a virtual payment card for use in performing the transaction in accordance with the results of the comparison. At step 825, the selected virtual payment card details such as card number, expiry date, CVV etc. are sent from the central server 260 to the merchant terminal 220 which then causes the transaction to be performed at step 830 by initiating payment authorisation using the selected card details in accordance with standard payment processing protocols.

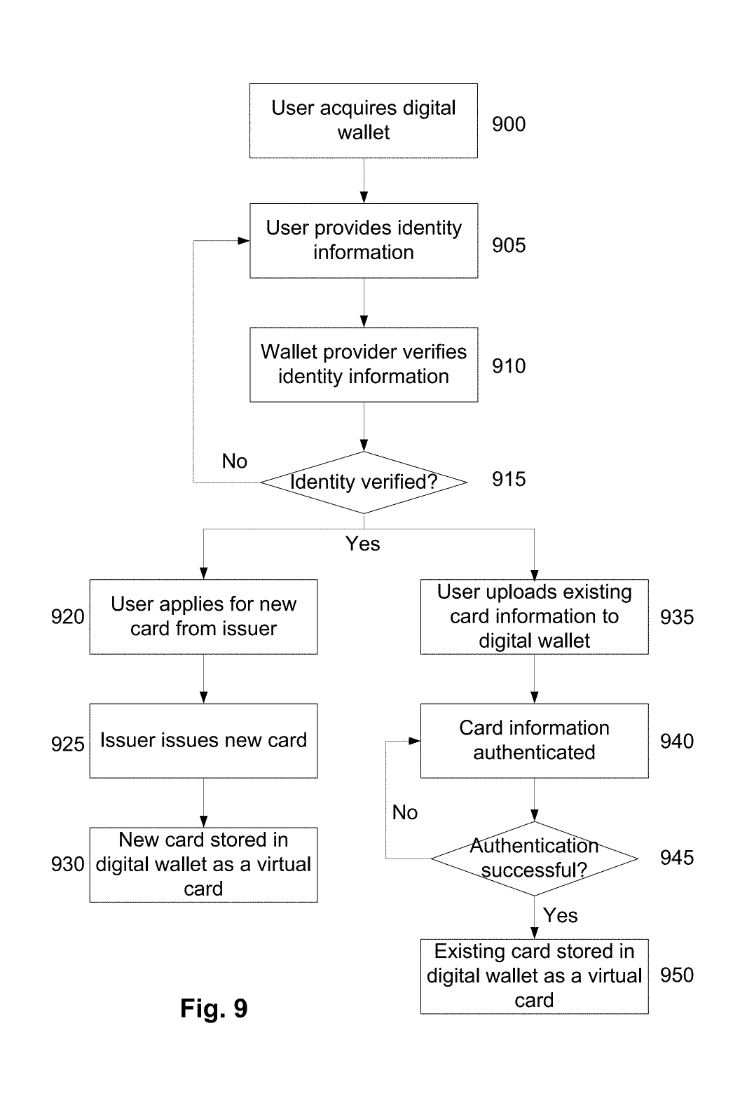

An example of a process of registering a digital wallet and creating virtual payment cards shall now be described with reference to FIG. 9.

In this example, at step 900 the user acquires a mobile or digital wallet application, for example by downloading the application onto their client device 230. The digital wallet application is initially blank and does not have any payment cards or accounts associated with it until the user has completed an identity verification process. At step 905, the user provides identity information which is stored in a server or other data repository accessible by the wallet provider. In one example, the user uploads Know Your Customer (KYC) documents such as Proof of Identity (PoI), Proof of Address (PoA), and personal details such as name, address, photo, gender, date of birth, phone number, mobile number, email address etc. At step 910, the wallet provider verifies the identity information. If the user's identity is successful verified at step 915, the user is marked as KYC approved or verified and the wallet is registered to the user. Certain functionality of the wallet is then enabled such as the ability to create virtual payment cards in the wallet.

In one example, at step 920 the user may apply for new payment cards from one or more issuers. Instead of needing to perform another KYC verification process, the issuer can use the KYC information already provided which is stored on the server in order to issue a new card at step 925. The issuer can use the KYC information already provided to create a virtual card with all of the necessary information embedded as currently required for the issuance of a plastic card. The new card can be issued as a virtual card to the user and be embedded or stored directly into the user's digital wallet as a virtual payment card at step 930. In this way, multiple issuers can issue multiple cards (credit, debit, reward etc.) to the user and embed them into the user's wallet without the user having to perform any further identity verification.

Alternatively, at step 935 the user may upload existing card information (such as card number, card or issuer name, issue and expiry date, CVV number etc.) to the digital wallet (e.g. existing plastic debit, credit, reward cards). At step 940, the wallet provider authenticates the card information using the KYC details previously authorized to ensure that the card being added belongs to the same user. This can be checked for example based on name, address, phone, email or mobile details of card holder and KYC details associated with the wallet. If authentication is successful at step 945, then at step 950 the existing card is stored in the digital wallet as a virtual card.

In an alternative example, an external e-KYC service may be used to verify the user's identity first time and also on a regular basis as stipulated by relevant regulations. For example, at step 905 the user may simply be asked to provide a unique identity number (such as Aadhaar number in India) and biometric information such as a fingerprint scan or a one-time password (OTP). This identity information may be sent to the external e-KYC service (such as UIDAI e-KYC) and based on the response received the user can be verified as KYC approved.

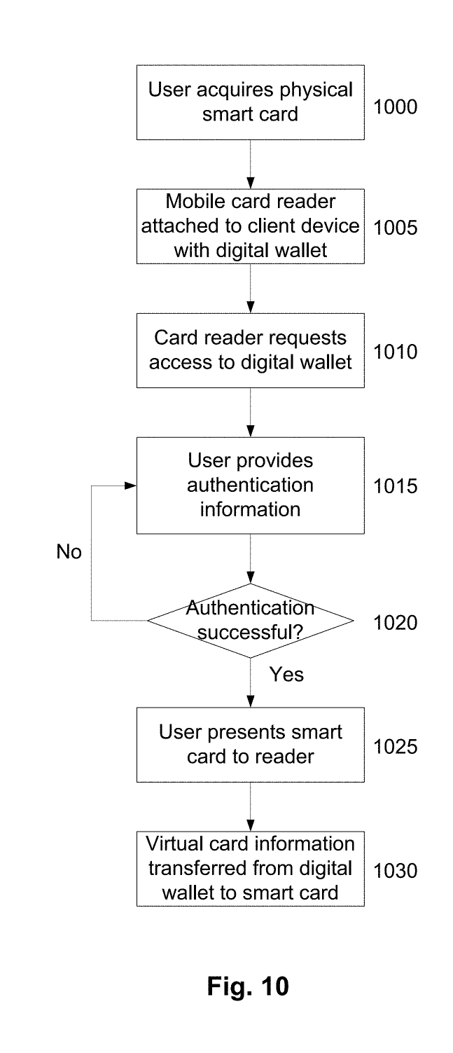

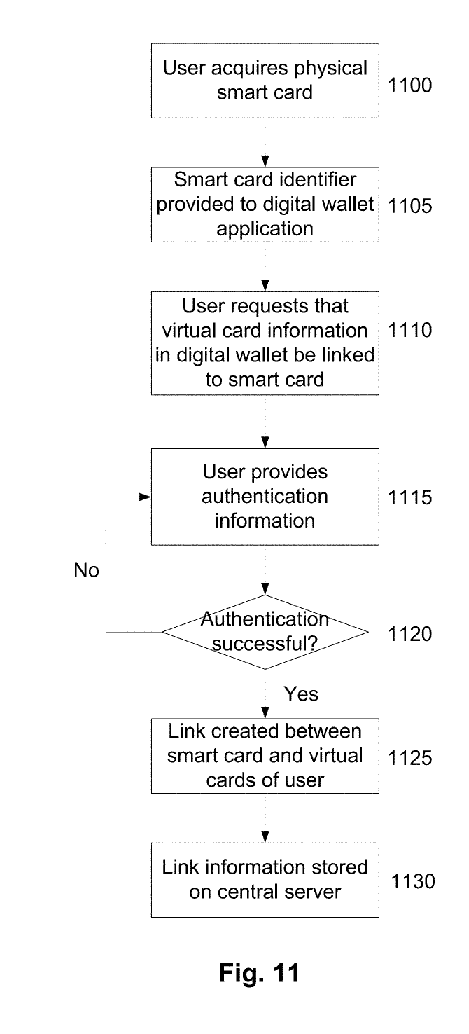

Now referring to FIG. 10, a flow chart of an example of a process of transferring virtual payment cards from a digital wallet to a smart card shall be described. In this example, at step 1000, the user acquires a physical smart card, which in this example, has an embedded processing system, memory, display, applications software etc. At step 1005, a mobile card reader 235 is attached to the client device 230 having the digital wallet application. At step 1010, the card reader 235 requests access to the digital wallet and in response at step 1015 the user provides authentication information such as a PIN, password, fingerprint or the like which enables the reader 235 to access the wallet. If authentication is successful at step 1020, the user may present their smart card 210 to the reader 235 at step 1025. At step 1030, the virtual card information (and associated transaction rules) embedded in the digital wallet is transferred from the digital wallet to the smart card 210. The smart card 210 is now associated with a plurality of virtual payment cards.

Now referring to FIG. 11, a flowchart of an example of a process of linking virtual payment cards to a smart card shall be described. In this example, at step 1100, the user acquires a physical smart card, which in this example, is not intended to store virtual payment card information or transaction rules. At step 1105, a smart card identifier is provided to the digital wallet application which may be responsive to link the smart card to the plurality of virtual payment cards stored in the digital wallet. Typically, the user will request that a link is made between the virtual card information in digital wallet and the smart card at step 1110. The user will then typically provide authentication information at step 1115 such as a PIN, password, fingerprint or the like to the digital wallet application. If authentication is successful at step 1120, a link is created between the smart card and plurality of virtual payment cards. The link information is then stored on the central server 260 at step 1130 for example in database 261. The database 261 may simply associate the smart card identifier with the virtual card information and transaction rules associated with each virtual card. In this way, the smart card 210 is now linked to the plurality of virtual payment cards.

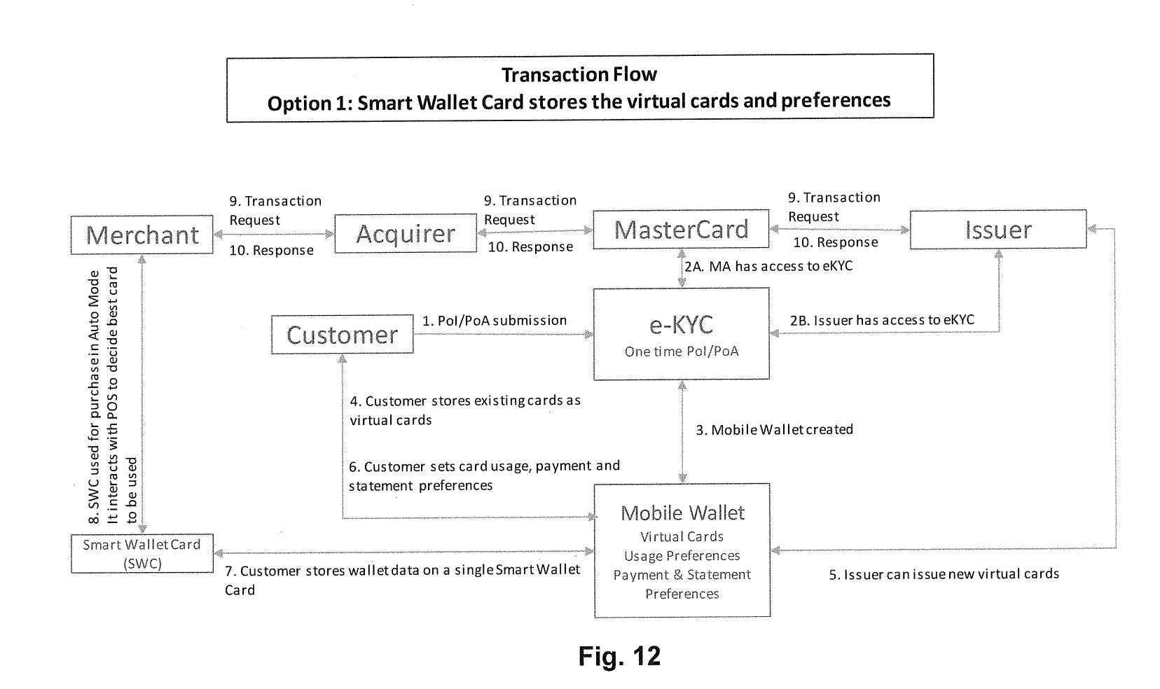

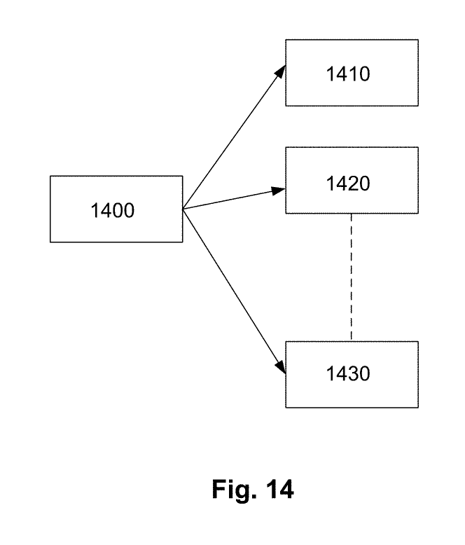

A schematic diagram of an example of the interactions involved in a typical smart card based transaction process shall now be described with reference to FIG. 12. The transaction flow in this diagram assumes that the smart wallet card (i.e. smart card) stores the virtual cards and usage preferences. The customer firstly creates a mobile wallet via a one time KYC process for example involving submission of PoI and PoA documents which card issuers and payment switching companies such as Mastercard have access to. Once the mobile wallet is created, the customer stores existing cards and virtual cards in the wallet or optionally requests an issuer to issue new virtual cards to the wallet. The customer then sets card usage and payment and statement preferences (discussed further in relation to FIG. 14) in the mobile wallet. The wallet data (virtual card information and usage preferences) are then stored on the smart card according to any of the processes previously discussed.

The smart card is then used to perform a transaction with a merchant in automatic mode. The smart card communicates with the merchant POS terminal and decides which of the virtual payment cards should be used to perform the transaction as previously described. The smart card then provides the selected virtual payment card information to the merchant terminal which initiates payment authorisation with an acquirer, card network and issuer in accordance with standard payment processing protocols.

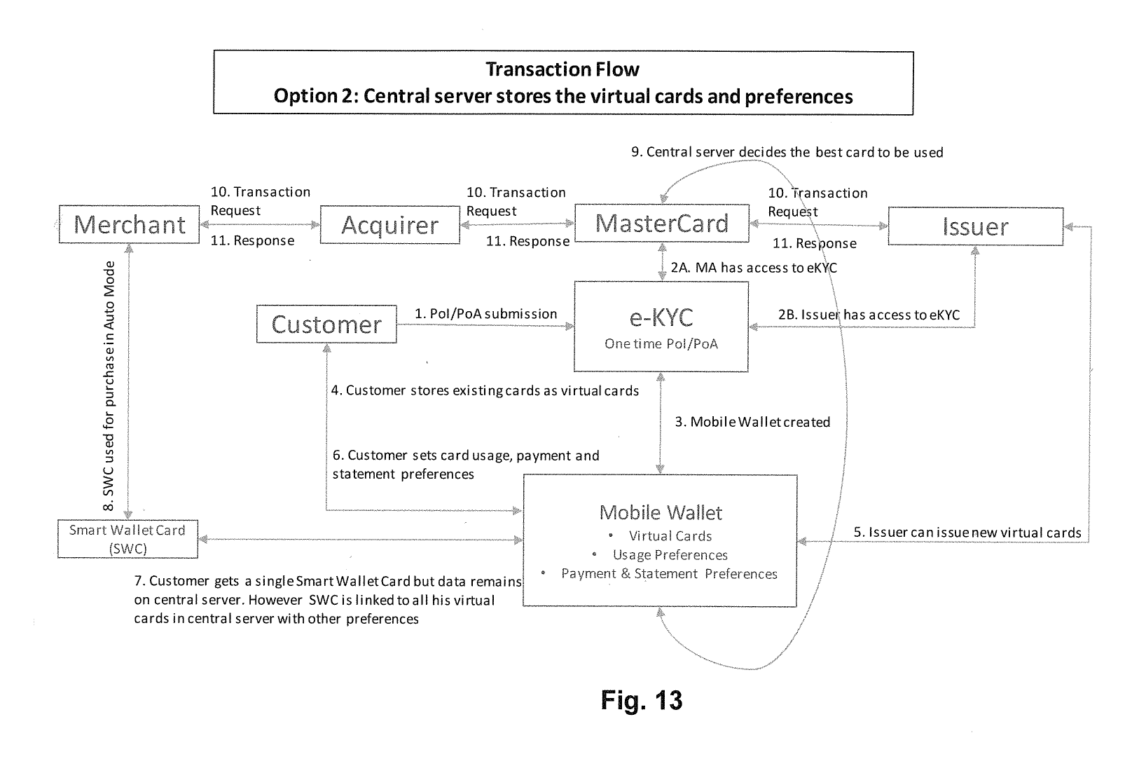

A schematic diagram of a further example of the interactions involved in a typical smart card based transaction process shall now be described with reference to FIG. 13. The transaction flow in this diagram assumes that a central server stores the virtual payment card information and usage preferences. The process flow is generally similar to that shown in FIG. 12, except that the smart card is simply linked to the virtual payment cards and usage preferences that are stored on the central server and as such does not store this data locally on the smart card.

The smart card is used to perform a transaction with a merchant in automatic mode.

The smart card communicates with the merchant POS terminal which is responsive to query the central server which decides which of the virtual payment cards should be used to perform the transaction. The central server then provides the selected virtual payment card information to the merchant terminal which initiates payment authorisation with an acquirer, card network and issuer in accordance with standard payment processing protocols.

Referring now to FIG. 14, there is shown a schematic diagram of an example of payment flow for the plurality of virtual payment cards. In this regard, it is to be appreciated that another benefit of the invention is that the user can consolidate payments and statements associated with the smart card. For example, instead of receiving a plurality of monthly statements for each virtual card and from multiple issuers, a single statement can be provided in respect of the smart card which shows card usage at issuer level for example. The user can configure the statement as desired along with rules for allocation of card payments through the digital wallet application.

For example, the user can make a single payment through their digital wallet that is allocated to each of the plurality of virtual payment cards in any desired manner. The single payment 1400 may for example be distributed proportionately to all issuers/virtual payment cards (1410, 1420, 1430) in either the billing amount ratio or in a pre-set order. In this way, the user does not need to make separate payments to each issuer or against each individual virtual card as they currently need to do for their physical payment cards. In addition, the user does not need to track multiple payment dates as only a single payment is required to be made for each statement that is received for the smart card.

Accordingly, it will be appreciated that the above described system enables a single physical card to be associated with or otherwise linked to a plurality of virtual payment cards (debit, credit, reward) or accounts issued by one or more issuers. The smart card can be used in manual or automatic modes in which the user either selects a virtual payment card for use in performing a transaction with a merchant or user-defined card usage or transaction rules are used to determine which of the virtual payment cards should be used for a particular merchant transaction. A one-time KYC process is also used which makes it easier for issuers to issue new cards to a customer without requiring identity verification procedures to be performed each time. Maintenance of personal details etc. can also be conducted once and will be automatically updated for each virtual card/issuer.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1) A smart card for use in performing an electronic transaction between a user and a merchant, the smart card including:
a) a data store for storing at least one of:
i) card information associated with a plurality of virtual payment cards; and,
ii) transaction rules indicative of user-defined card usage parameters associated with each of the plurality of virtual payment cards;
b) an electronic processing device that:
i) receives transaction information indicative of one or more parameters of the transaction between the user and merchant;
ii) compares the transaction rules for each of the plurality of virtual payment cards with the transaction information;
iii) selects one of the plurality of virtual payment cards for use in performing the transaction in accordance with results of the comparison; and,
iv) provides card information associated with the selected virtual payment card to the merchant to thereby enable the transaction to be performed.

2) The smart card according to claim 1, wherein the plurality of virtual payment cards are associated with a digital wallet of the user, and wherein the card information and transaction rules are transferred from the digital wallet to the smart card.

3) The smart card according to claim 1, wherein the smart card further includes a display and the processing system is configured to:
a) determine the virtual payment card that has been selected for use in performing the transaction;
b) generate a representation indicative of the selected virtual payment card; and,
c) display the representation on the display of the smart card.

4) The smart card according to claim 1, wherein the smart card includes a user interface for allowing the user to select whether the card is to be operated in automatic or manual mode.

5) A method for use in performing an electronic transaction between a user and a merchant using a smart card associated with a plurality of virtual payment cards, the method including in one or more electronic processing devices:
a) determining transaction information in response to the user initiating a transaction with a merchant using the smart card, the transaction information indicative of one or more parameters of the transaction between the user and merchant;
b) determining transaction rules indicative of user-defined card usage parameters associated with each of the plurality of virtual payment cards;
c) comparing the transaction rules for each of the plurality of virtual payment cards with the transaction information;
d) determining one of the plurality of virtual payment cards for use in performing the transaction in accordance with results of the comparison; and,
e) providing card information associated with the virtual payment card determined for use to the merchant to thereby enable the transaction to be performed.

6) The method according to claim 5, wherein the transaction with the merchant is initiated at one of:
a) a point of sale; and,
b) an e-commerce store.

7) The method according to claim 5, wherein an indication of a card identifier is provided to a merchant system, the merchant system being responsive to:
a) determine that the card identifier is indicative of a smart card associated with a plurality of virtual payment cards;
b) generate the transaction information; and,
c) provide an indication of the transaction information to a smart card processing system.

8) The method according to claim 7, wherein the smart card processing system is one of:
a) embedded onto the smart card; and,
b) a remote or central server,
and wherein the smart card processing system is responsive to receiving the indication of the transaction information to:
c) determine the transaction rules associated with each of the plurality of virtual payment cards associated with the smart card;
d) compare the transaction rules to the transaction information; and,
e) select the virtual payment card in accordance with results of the comparison.

9) The method according to claim 6, wherein the transaction information is indicative of one or more parameters of the transaction including:
a) a transaction amount;
b) a merchant identifier;
c) a date of transaction; and,
d) a location of transaction,
and wherein the transaction rules associated with each of the plurality of virtual payment cards are based at least in part on one or more of:
e) a transaction amount;
f) a merchant identifier;
g) a date of transaction; and,
h) a location of transaction.

10) The method according to claim 9, wherein the smart card processing system:
a) retrieves card information associated with the selected virtual payment card; and,
b) provides the card information to the merchant system.

11) The method according to claim 10, wherein the card information includes one or more of:
a) a card number;
b) an issuer name;
c) an issue date;
d) an expiry date;
e) a card verification value (CVV);
f) an account name; and,
g) an account balance.

12) The method according to claim 10, wherein in response to receiving the selected card information, the merchant system:
a) prompts the user to provide authentication information;
b) selectively authenticates the user using the authentication information; and,
c) initiates payment authorisation with a payment processing system in response to successful authentication.

13) The method according to claim 12, wherein the authentication information is associated with one of:
a) the smart card; and,
b) the selected virtual payment card, and
wherein the authentication information is one or more of:
c) a personal identification number (PIN);
d) a password; and,
e) a biometric identifier.

14) The method according to claim 5, wherein each of the plurality of virtual payment cards are indicative of one of:
a) a debit card;
b) a credit card; and,
c) a reward card.

15) The method according to claim 5, wherein the card information associated with each of the plurality of virtual payment cards and transaction rules associated with said payment cards are associated with a digital wallet of the user.

16) The method according to claim 15, wherein the card information and transaction rules are transferred from the digital wallet to the smart card processing system.

17) The method according to claim 15, wherein the card information and transaction rules are stored in one of:
a) a data store embedded onto the smart card; and,
b) the remote server.

18) The method according to claim 15, wherein the card information and transaction rules are wirelessly transferred to the smart card via one of:
a) a card reader attached to a user device associated with the digital wallet;
b) an automated teller machine (ATM); and,
c) a payment terminal.

19) The method according to claim 15, wherein the digital wallet is initially registered by providing identity information to a wallet provider, the wallet provider being responsive to verify the user's identity in accordance with Know Your Customer (KYC) protocols.

20) The method according to claim 19, wherein after a one-time KYC approval process to register the digital wallet, the user is able to at least one of:
a) apply for a new payment card from an issuer, the issuer being responsive, without further identity verification to:
i) issue a new payment card; and.
ii) embed said payment card in the user's digital wallet as a virtual payment card; and,
b) upload card information associated with one or more existing payment cards into the digital wallet to create one or more virtual payment cards.
